(19) United States
(12) Patent Application Publication
(10) Pub. No.: US 2021/0323247 A1
(43) Pub. Date: Oct. 21, 2021

(54) PREPREG AUTOMATIC LAYERING DEVICE

(71) Applicant: MITSUBISHI HEAVY INDUSTRIES, LTD., Tokyo (JP)

(72) Inventors: Masayuki KAWANO, Tokyo (JP); Yukiharu YAMASAKI, Tokyo (JP); Yukifumi TOYAMA, Tokyo (JP)

(21) Appl. No.: 17/271,664

(22) PCT Filed: Sep. 3, 2019
(86) PCT No.: PCT/JP2019/034538

§ 371 Date: Feb. 26, 2021

(30) Foreign Application Priority Data
Oct. 31, 2018 (JP) 2018-205825

(51) Int. Cl. B29C 70/38; B29C 70/54; B29C 70/34

(52) U.S. Cl. CPC B29C 70/38; B29C 70/34; B29C 70/54

(57) ABSTRACT

Compactors arranged adjacent to each other in one direction are independent of one another. A raising and lowering mechanism raises and lowers the compactors independently of one another. A control device controls the raising and lowering mechanism.

### TECHNICAL FIELD

The present invention relates to a prepreg automatic layering device.

Priority is claimed on Japanese Patent Application No. 2018-205825, filed Oct. 31, 2018, the content of which is incorporated herein by reference.

### BACKGROUND ART

When a fuselage, a main wing, or the like of an aircraft is produced, a prepreg layered body, which is formed by layering a plurality of prepreg sheets which are fiber sheets infiltrated with resin, is used.

As the resin to be infiltrated into the fiber sheet, an ultraviolet curable resin, a thermosetting resin, or the like which is in a semi-cured state (incompletely cured state) and has adhesion is used.

The prepreg layered body is formed by removing a delamination sheet from prepreg sheets and integrally layering a plurality of the prepreg sheets while setting fiber directions to intersect each other.

Namely, the prepreg layered body is produced by repeating a step in which for example, a prepreg sheet (angled layer) of which the fiber direction is directed to 45 degrees or 90 degrees is layered on a prepreg sheet (0-degree layer) of which the fiber direction is directed to 0 degrees, and a prepreg sheet (0-degree layer) of which the fiber direction is directed to 0 degrees is layered thereon.

When the prepreg layered body is produced, a prepreg automatic layering device is used (for example, refer to PTL 1).

PTL 1 discloses a prepreg automatic layering device including a lay-up stage which extends in one direction and on the upper surface of which prepreg sheets are to be layered, and a prepreg layering head.

The prepreg layering head disclosed in PTL 1 includes a supply roller, a support roller, a rotary die cutter, a pair of guide rollers, a scraper roller, a plurality of compactors (layering shoes), and a delamination sheet recovery roller.

The supply roller supplies the prepreg sheet to which a delamination sheet is attached. The support roller supports the prepreg sheet to which the delamination sheet is attached.

The rotary die cutter is provided on a supply roller side, and cuts the prepreg sheet such that the prepreg sheet is divided in a width direction.

The pair of guide rollers guide the prepreg sheet fed from the support roller. The scraper roller delaminates the delamination sheet from the prepreg sheet.

The plurality of compactors (layering shoes) are provided to be able to advance and retreat in the fiber direction of the prepreg sheet, and press the prepreg sheet, which is guided to a region between the pair of guide rollers, from one surface side. The delamination sheet recovery roller recovers the delamination sheet.

The plurality of compactors are configured such that lifting and lowering motions are collectively controllable, and move in a direction toward an end on the other side in a width direction of the lay-up stage in a state where the plurality of compactors are arranged side by side at an end on one side in the width direction of the lay-up stage.

The prepreg automatic layering device changes an angle formed by a direction in which the lay-up stage extends and a supply direction of the prepreg sheet, to press the entirety of a region having a parallelogram shape or a quadrilateral shape (include also a rectangular shape) on the prepreg sheet.

### CITATION LIST

### Patent Literature

[PTL 1] Japanese Patent No. 5422439

### SUMMARY OF INVENTION

### Technical Problem

However, in PTL 1, since the lifting and lowering motions of the plurality of compactors are collectively controlled, it is difficult to press only a region having a trapezoidal shape or a triangular shape (predetermined region) on the prepreg sheet to be layered on the lay-up stage or another prepreg sheet.

In addition, as disclosed in PTL 1, when the lifting and lowering motions of the plurality of compactors are collectively controlled, since the pressed width of the prepreg sheet is determined by the number of the plurality of compactors, it is difficult to change the width of the region pressed by the plurality of compactors (the width of a parallelogram shape or the width of a quadrilateral shape).

Namely, in the prepreg automatic layering device disclosed in PTL 1, it is difficult to improve the degree of freedom in the shape (including also the outer shape and the width) of the predetermined region pressed by the compactors.

Therefore, an object of the present invention is to provide a prepreg automatic layering device capable of improving the degree of freedom in the shape of a predetermined region on a prepreg sheet, which is pressed by compactors.

### Solution to Problem

In order to solve the above problem, according to one aspect of the present invention, there is provided a prepreg automatic layering device including: a lay-up stage extending in one direction; and a prepreg layering head including a feeding portion that feeds a prepreg sheet, which is affixed to one surface of a delamination sheet, onto the lay-up stage or another prepreg sheet disposed on the lay-up stage, a winding portion that winds the delamination sheet delaminated from the prepreg sheet, and a plurality of compactors that are disposed in the one direction and move in a direction from a winding portion side toward a feeding portion side to press a predetermined region on the prepreg sheet with the delamination sheet interposed between the plurality of compactors and the prepreg sheet. The plurality of compactors are disposed to be adjacent to each other on one side and are configured to be independent of each other. The prepreg layering head includes a lifting and lowering mechanism that independently lifts and lowers the plurality of compactors, and a control unit that controls the lifting and lowering mechanism.

According to the present invention, the plurality of compactors disposed to be adjacent to each other on one side are configured to be independent of each other, and the lifting and lowering mechanism that independently lifts and lowers the plurality of compactors, and the control device that controls the lifting and lowering mechanism are provided. Therefore, while the compactors are located above the predetermined region on the prepreg sheet, the compactors can be lowered, and while the compactors are located above a region other than the predetermined region on the prepreg sheet, the compactors can be lifted to not press the prepreg sheet.

Accordingly, the degree of freedom in the shape (including the outer shape and the width) of the predetermined region on the prepreg sheet, which is pressed by the compactors, can be improved.

In addition, in the prepreg automatic layering device according to one aspect of the present invention, while the compactor is located above the predetermined region on the prepreg sheet, the control unit may perform control to lower the compactor to a position where the prepreg sheet is pressible, and while the compactor is located in a region outside the predetermined region, the control unit may perform control to lift the compactor above the prepreg sheet to cause the compactor to be separated from the delamination sheet.

Since the control device which performs such control is provided, only the predetermined region on the prepreg sheet can be pressed.

In addition, when the compactor is located above a portion of the prepreg sheet, which is other than the prepreg cut portion, the compactor is lifted, so that the compactor is separated from the delamination sheet. Therefore, the portion of the prepreg sheet other than the prepreg cut portion is not pressed by the compactor. Accordingly, the portion of the prepreg sheet other than the prepreg cut portion can be suppressed from being delaminated from the delamination sheet.

In addition, in the prepreg automatic layering device according to one aspect of the present invention, the predetermined region on the prepreg sheet may be a prepreg cut portion obtained by cutting a part of the prepreg sheet into a predetermined shape.

As described above, since the prepreg cut portion obtained by cutting a part of the prepreg sheet into a predetermined shape is used as the predetermined region on the prepreg sheet, the prepreg cut portion can be layered on the lay-up stage or the another prepreg sheet.

In addition, in the prepreg automatic layering device according to one aspect of the present invention, the prepreg layering head may include a cutter portion that is provided downstream of the feeding portion and in a proceding stage of the lay-up stage to cut the prepreg sheet in a width direction, and a clamp portion that clamps the delamination sheet and the prepreg sheet located between the feeding portion and the cutter portion, to stop feeding of the delamination sheet and the prepreg sheet. While the compactor presses the predetermined region on the prepreg sheet, the control unit may control the clamp portion to clamp the delamination sheet and the prepreg sheet and cause rotation of the winding portion to stop.

As described above, while the compactor presses the predetermined region on the prepreg sheet, the clamp portion clamps the delamination sheet and the prepreg sheet, and the rotation of the winding portion is stopped. Therefore, the tension applied to the delamination sheet and the prepreg sheet can be reduced.

Accordingly, when among the plurality of compactors, the predetermined region is pressed only by a part of the compactors, shearing force generated in the delamination sheet and the prepreg sheet can be reduced. Therefore, damage to the delamination sheet and the prepreg sheet can be suppressed.

### Advantageous Effects of Invention

According to the present invention, the degree of freedom in the shape of the predetermined region on the prepreg sheet, which is pressed by the compactors, can be improved.

### BRIEF DESCRIPTION OF DRAWINGS

FIG. 1 is a side view schematically illustrating a schematic configuration of a prepreg automatic layering device according to an embodiment of the present invention.

FIG. 2 is a functional block diagram of a control device illustrated in FIG. 1.

FIG. 3 is a plan view for describing a state of compactors immediately after the start of a process of pressing a prepreg cut portion having a trapezoidal shape in a plan view.

FIG. 4 is a cross-sectional view of a structure illustrated in FIG. 3 taken along a C₁-C₂ line direction.

FIG. 5 is a plan view for describing a state of the compactors that press an intermediate region on the prepreg cut portion having a trapezoidal shape in a plan view.

FIG. 6 is a cross-sectional view of a structure illustrated in FIG. 5 taken along an E₁-E₂ line direction.

FIG. 7 is a plan view for describing a state of the compactors immediately after the end of the process of pressing the prepreg cut portion having a trapezoidal shape in a plan view.

FIG. 8 is a cross-sectional view of a structure illustrated in FIG. 7 taken along an F₁-F₂ line direction.

FIG. 9 is a plan view for describing a state of a plurality of the compactors when a prepreg cut portion having a rectangular shape with a narrow width is pressed.

FIG. 10 is a plan view for describing a state of the plurality of compactors when a prepreg cut portion having a parallelogram shape with a narrow width is pressed.

### DESCRIPTION OF EMBODIMENTS

Hereinafter, an embodiment to which the present invention is applied will be described in detail with reference to the drawings.

### Present Embodiment

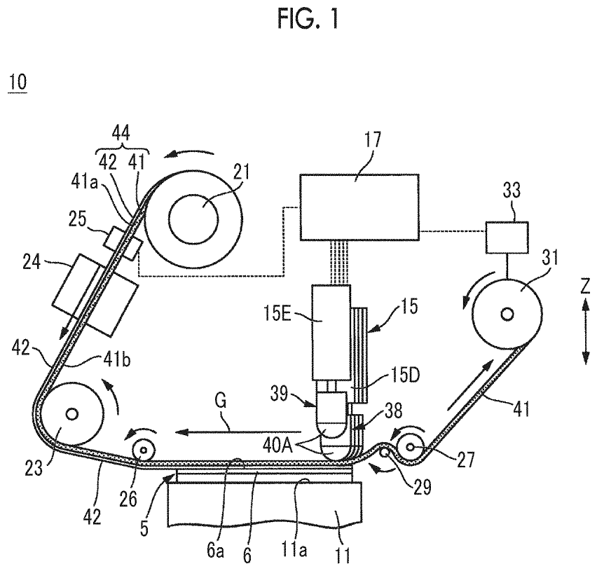

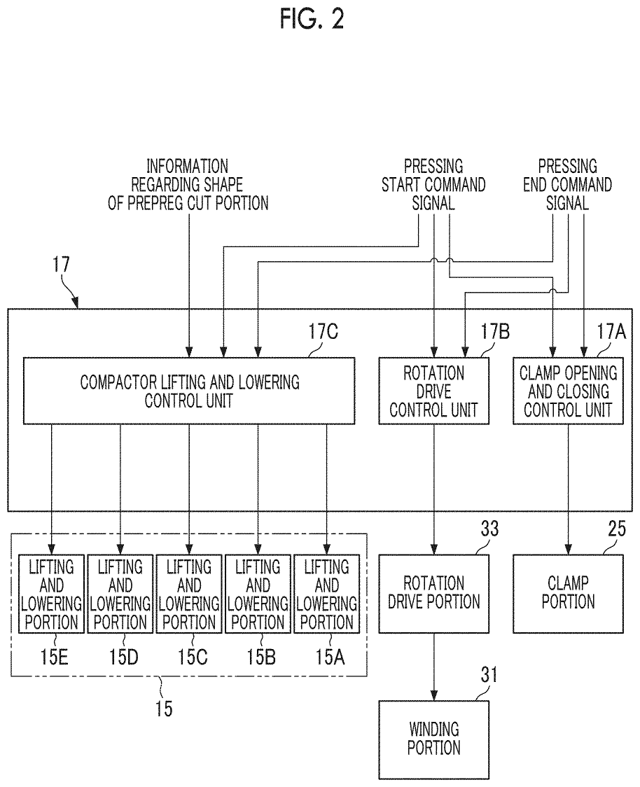

A prepreg automatic layering device 10 according to the present embodiment of the present invention will be described with reference to FIGS. 1 to 8.

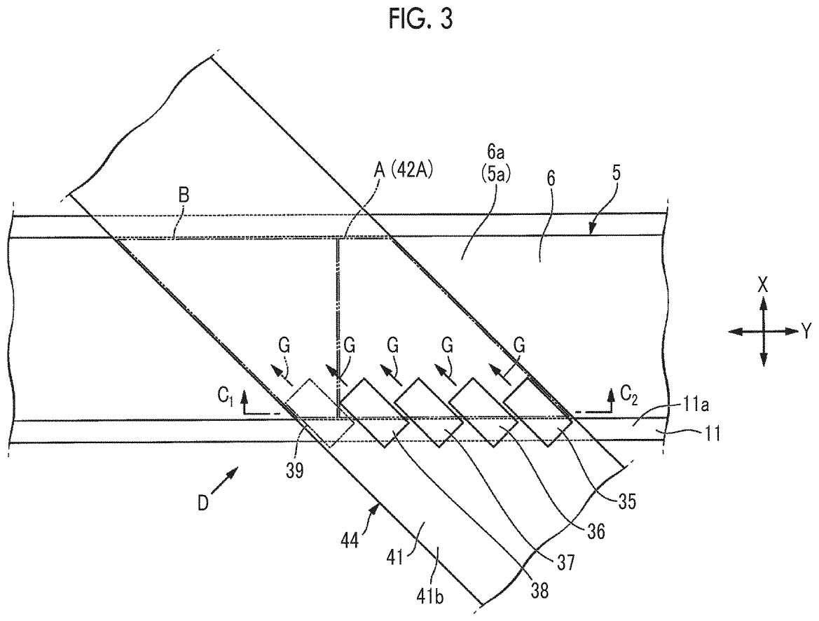

FIG. 1 is a view of the prepreg automatic layering device 10 of the present embodiment when seen in a D direction illustrated in FIG. 3. In FIG. 1, among a plurality of arrows, a part of arrows indicates a rotational direction of components forming the prepreg automatic layering device 10, and the remaining arrows indicate a transfer direction of a delamination sheet 41 and a prepreg sheet 42.

In FIGS. 1, 3, and 5, G indicates a direction in which compactors 35 to 39 (a plurality of compactors) move when a prepreg cut portion 42A is pressed.

In FIGS. 3, 5, and 7, the compactors 37 to 39 indicated by dotted lines indicate compactors that do not press the delamination sheet 41.

In FIGS. 3 to 8, A indicates a predetermined region, which is required to be pressed by the compactors 35 to 38 (hereinafter, referred to as a “predetermined region A”), on the prepreg sheet 42 disposed on another prepreg sheet 6, and B indicates a region, which is not required to be pressed by the compactors 35 to 39 (hereinafter, referred to as a “pressing unnecessary region B”), on the prepreg sheet 42 disposed on the another prepreg sheet 6.

In FIGS. 1, 4, 6, and 8, Z indicates a vertical direction. In FIGS. 3, 5, and 7, an X direction indicates a width direction of a lay-up stage 11 orthogonal to a Z direction.

In FIGS. 3, 5, and 7, a Y direction is a direction orthogonal to the X direction and the Z direction, and indicates one direction in which the lay-up stage 11 extends (also a direction in which the lay-up stage 11 moves). In FIGS. 1 to 8, the same components are denoted by the same reference signs.

In the present embodiment, as an example, a case where the prepreg cut portion 42A is layered on an upper surface 6a of the another prepreg sheet 6 (upper surface 5a of a prepreg layered body 5) forming the uppermost layer of the prepreg layered body 5 in the process of production which is disposed on an upper surface 11a of the lay-up stage 11 and in which a plurality of prepreg sheets are layered will be described below.

The prepreg automatic layering device 10 includes the lay-up stage 11 and a prepreg layering head 13.

The lay-up stage 11 extends in the Y direction. The upper surface 11a of the lay-up stage 11 is a flat surface. The prepreg layered body 5 in the process of production is placed on the upper surface 11a of the lay-up stage 11. The upper surface 5a of the prepreg layered body 5 is formed of the upper surface 6a of the another prepreg sheet 6 forming the uppermost layer of the prepreg layered body 5.

The prepreg layering head 13 includes a feeding portion 21, a support roller 23, a rotary die cutter 24 (cutter portion), a clamp portion 25, guide rollers 26 and 27, and a scraper roller 29, a winding portion 31, a rotation drive portion 33, compactors 35 to 39, a lifting and lowering mechanism 15, and a control device 17.

The feeding portion 21 is provided on one side in the width direction of the lay-up stage 11 and above the lay-up stage 11. The feeding portion 21 is a columnar member that is rotatable around a rotation axis thereof.

A sheet member 44 is wound around an outer peripheral surface of the feeding portion 21. The sheet member 44 is configured such that the prepreg sheet 42 is affixed to one surface 41a of the delamination sheet 41. The delamination sheet 41 is disposed on a side facing the outer peripheral surface of the feeding portion 21.

The feeding portion 21 feeds the sheet member 44 onto the upper surface 6a of the another prepreg sheet 6.

The support roller 23 is provided on the one side in the width direction of the lay-up stage 11. The support roller 23 is disposed at a position that is located below the feeding portion 21 and is farther separated from the lay-up stage 11 in the X direction than the feeding portion 21.

The support roller 23 has a columnar shape and is configured to be rotatable around a rotation axis thereof. An outer peripheral surface of the support roller 23 is in contact with the other surface 41b of the delamination sheet 41 forming the sheet member 44 fed from the feeding portion 21.

The support roller 23 supports the sheet member 44 such that the sheet member 44 fed from the feeding portion 21 faces an upper surface 6a side of the another prepreg sheet 6.

The rotary die cutter 24 is provided between the feeding portion 21 and the support roller 23. The rotary die cutter 24 cuts the prepreg sheet 42 forming the sheet member 44 in the width direction, the prepreg sheet 42 being disposed between the feeding portion 21 and the support roller 23.

The rotary die cutter 24 cuts only the prepreg sheet 42. For this reason, the prepreg sheet 42 after cut is supported on the support roller 23 in a state where the prepreg sheet 42 is affixed to the delamination sheet 41.

A portion corresponding to the predetermined region A on the prepreg sheet 42 (a part of the prepreg sheet 42) is cut between the feeding portion 21 and the rotary die cutter 24, so that the prepreg cut portion 42A is formed.

Incidentally, when it is difficult to cut the prepreg sheet 42 only with the rotary die cutter 24, separately, an operator cuts the prepreg sheet 42 with a cutter.

The clamp portion 25 is disposed between the feeding portion 21 and the rotary die cutter 24. The clamp portion 25 clamps the sheet member 44 located between the feeding portion 21 and the rotary die cutter 24, to regulate the position of the sheet member 44.

The guide roller 26 is provided on the one side in the width direction of the lay-up stage 11. The guide roller 26 is disposed at a position that is lower than the support roller 23 and is closer to the lay-up stage 11 than the support roller 23.

The guide roller 26 has a columnar shape and is configured to be rotatable around a rotation axis thereof. An outer peripheral surface of the guide roller 26 is in contact with the other surface 41b of the delamination sheet 41 forming the sheet member 44. The guide roller 26 guides the prepreg sheet 42 to the upper surface 6a of the another prepreg sheet 6.

The guide roller 27 is provided on the other side in the width direction of the lay-up stage 11. The guide roller 27 has a columnar shape and is configured to be rotatable around a rotation axis thereof. An outer peripheral surface of the guide roller 27 is in contact with the other surface 41b of the delamination sheet 41. The guide roller 27 guides the delamination sheet 41 in a direction toward the winding portion 31.

The scraper roller 29 is provided on the other side in the width direction of the lay-up stage 11. The scraper roller 29 is provided between the guide roller 27 and the lay-up stage 11.

The scraper roller 29 has a columnar shape and is configured to be rotatable around a rotation axis thereof. An outer peripheral surface of the scraper roller 29 is in contact with the one surface 41a of the delamination sheet 41. The scraper roller 29 delaminates the delamination sheet 41 from the prepreg sheet 42.

The winding portion 31 is disposed at a position which is located above the guide roller 27 and is farther separated from the lay-up stage 11 than the guide roller 27.

The winding portion 31 has a columnar shape and is configured to be rotatable around a rotation axis thereof. An outer peripheral surface of the winding portion 31 is in contact with the other surface 41b of the delamination sheet 41. When the winding portion 31 rotates, the delamination sheet 41 is wound.

The rotation drive portion 33 is a drive portion that rotates the winding portion 31. When the winding portion is rotated by the rotation drive portion 33, the delamination sheet 41 is wound. When the rotation of the winding portion 31 is stopped, the winding of the delamination sheet 41 is stopped.

The compactors 35 to 39 are disposed to be adjacent to each other in order of the compactor 35, the compactor 36, the compactor 37, the compactor 38, and the compactor 39 in the Y direction from the predetermined region A toward the pressing unnecessary region B.

The compactors 35 to 39 are disposed above the sheet member 44 located above the lay-up stage 11. The compactors 35 to 39 each are configured to be independent of other compactors (four compactors out of the compactors 35 to 39). Accordingly, the compactors 35 to 39 each are configured to be liftable and lovable independently of the other compactors.

The compactors 35 to 39 each include a protrusion 40A that forms a lower portion of each of the compactors 35 to 39 and has an arc shape protruding in a direction from above to below.

When the protrusions 40A press the delamination sheet 41, only the prepreg cut portion 42A is pressed with the delamination sheet 41 interposed therebetween. When the prepreg cut portion 42A is pressed, the compactors 35 to 39 move in a G direction in a state where the compactors 35 to 39 are arranged side by side in the X direction.

Incidentally, the prepreg automatic layering device 10 includes a head direction adjusting mechanism (not illustrated) that changes the direction of the prepreg layering head 13 (direction in which the sheet member 44 is supplied) with respect to a direction in which the lay-up stage 11 or the another prepreg sheet 6 extends.

When the head direction adjusting mechanism changes the direction of the prepreg layering head 13, the direction of the compactors 35 to 39 is changed to face a direction opposite a supply direction of the sheet member 44.

The lifting and lowering mechanism 15 includes lifting and lowering portions 15A to 15E.

The lifting and lowering portion 15A is provided above the compactor 35 and is connected to the compactor 35. The lifting and lowering portion 15A lifts and lowers only the compactor 35.

The lifting and lowering portion 15B is provided above the compactor 36 and is connected to the compactor 36. The lifting and lowering portion 15B lifts and lowers only the compactor 36.

The lifting and lowering portion 15C is provided above the compactor 37 and is connected to the compactor 37. The lifting and lowering portion 15C lifts and lowers only the compactor 37.

The lifting and lowering portion 15D is provided above the compactor 38 and is connected to the compactor 38. The lifting and lowering portion 15D lifts and lowers only the compactor 38.

The lifting and lowering portion 15E is provided above the compactor 39 and is connected to the compactor 39. The lifting and lowering portion 15E lifts and lowers only the compactor 39.

The control device 17 includes a clamp opening and closing control unit 17A, a rotation drive control unit 17B, and a compactor lifting and lowering control unit 17C.

The clamp opening and closing control unit 17A is electrically connected to the clamp portion 25. When a pressing start command signal (signal to start the pressing of the prepreg cut portion 42A) is input to the clamp opening and closing control unit 17A, the clamp opening and closing control unit 17A controls the clamp portion 25 to clamp the sheet member 44 to regulate the position of the sheet member 44.

In addition, when a pressing end command signal (signal to end the pressing of the prepreg cut portion 42A) is input to the clamp opening and closing control unit 17A, the clamp opening and closing control unit 17A controls the clamp portion 25 to release the clamping of the sheet member 44.

The rotation drive control unit 17B is electrically connected to the rotation drive portion 33. When the pressing start command signal is input to the rotation drive control unit 17B, the rotation drive control unit 17B controls the rotation drive portion 33 to stop the rotation of the winding portion 31.

In addition, when the pressing end command signal is input to the rotation drive control unit 17B, the rotation drive control unit 17B controls the rotation drive portion 33 to restart the rotation of the winding portion 31.

The compactor lifting and lowering control unit 17C is electrically connected to each of the lifting and lowering portions 15A to 15E. The compactor lifting and lowering control unit 17C independently controls each of the lifting and lowering portions 15A to 15E.

The compactor lifting and lowering control unit 17C stores a drive program corresponding to various shapes (a quadrilateral shape, a trapezoidal shape, a triangular shape, a parallelogram shape having different widths, and the like) of the prepreg cut portion 42A.

The drive program includes information regarding the positions in a height direction of the compactors 35 to 39 in an initial state, information on moving speed, and the like.

When the information regarding the shape of the prepreg cut portion 42A to be processed is input to the compactor lifting and lowering control unit 17C, the compactor lifting and lowering control unit 17C controls the lifting and lowering portions 15A to 15E to lift and lower the compactors 35 to 39 during a period from the start of pressing to the end of pressing of the prepreg cut portion 42A.

Here, referring to FIGS. 3 to 8, a process of pressing the prepreg cut portion 42A, which is to be performed by the control device 17, will be described as an example based on when the prepreg cut portion 42A having a trapezoidal shape is pressed.

Initially, when the pressing start command signal is received, the clamp opening and closing control unit 17A causes the sheet member 44 to be clamped, and the rotation drive control unit 17B causes the rotation of the winding portion 31 to stop. Accordingly, the tension applied to the sheet member 44 is smaller than the tension applied thereto when the sheet member 44 is wound.

As described above, since the tension applied to the sheet member 44 is reduced before the pressing of the prepreg cut portion 42A is started, when among the compactors 35 to 39 (plurality of compactors), only a part of the compactors presses the predetermined region A, shearing force generated in the sheet member 44 can be reduced. Accordingly, damage to the sheet member 44 can be suppressed.

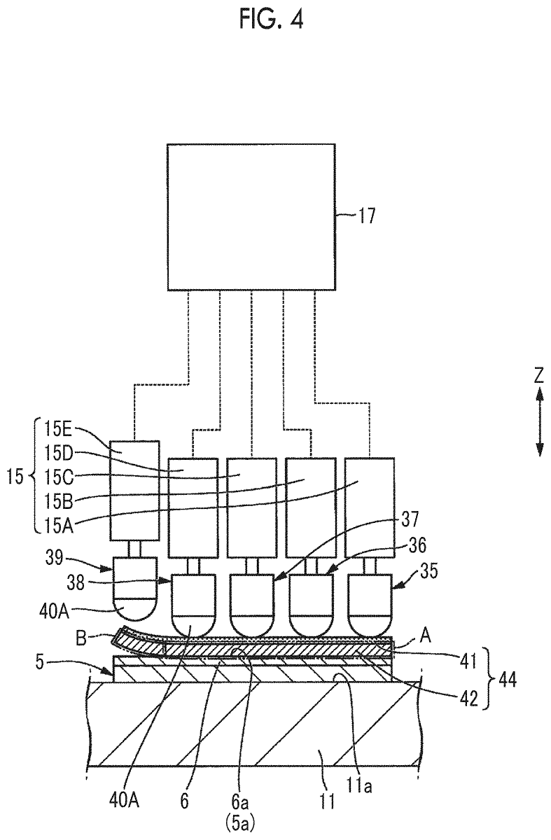

Next, the compactor lifting and lowering control unit 17C controls the lifting and lowering portions 15A to 15E to lower the compactors 35 to 38 to a position where the compactors 35 to 38 located above the predetermined region A (namely, the prepreg cut portion 42A) at a pressing start position (end of the prepreg cut portion 42A, which is located on the other side in the width direction) can press the delamination sheet 41, and causes the compactor 39 to be lifted to a position where the compactor 39 located above the pressing unnecessary region B is separated from the delamination sheet 41 corresponding to the pressing unnecessary region B (refer to FIGS. 3 and 4).

Thereafter, while the positions in the height direction of the compactors 35 to 39 are maintained, the compactors 35 to 39 move in the G direction to press a part of the predetermined region A.

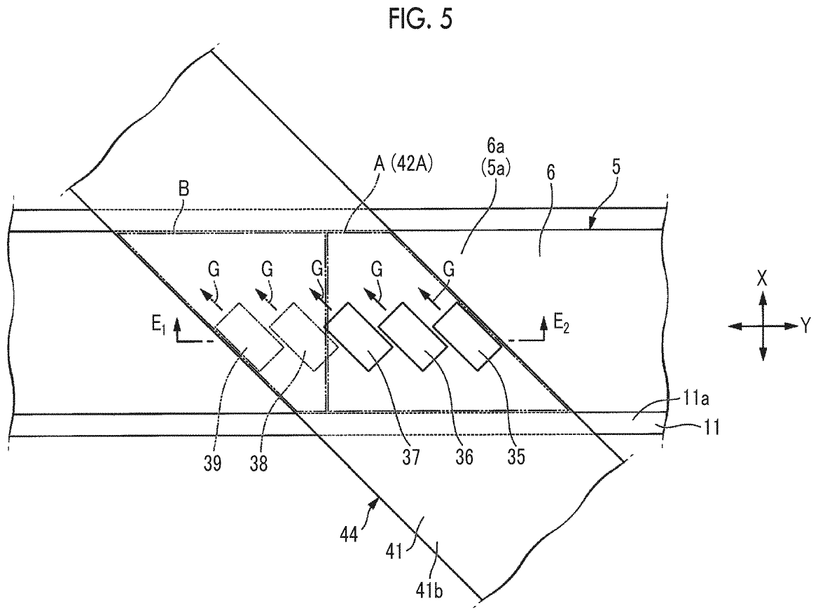

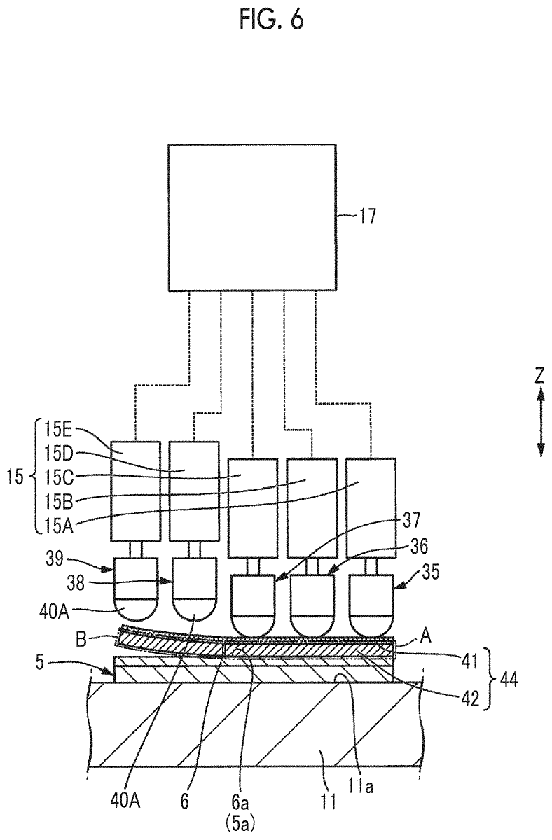

Next, immediately before the protrusion 40A of the compactor 38 moves to the pressing unnecessary region B, the compactor lifting and lowering control unit 17C causes the compactor 38 to be lifted, so that the protrusion 40A of the compactor 38 is separated above from the delamination sheet 41 (refer to FIGS. 5 and 6).

Thereafter, while the positions in the height direction of the compactors 35 to 39 are maintained, the compactors 35 to 39 move in the G direction to continue to press the predetermined region A.

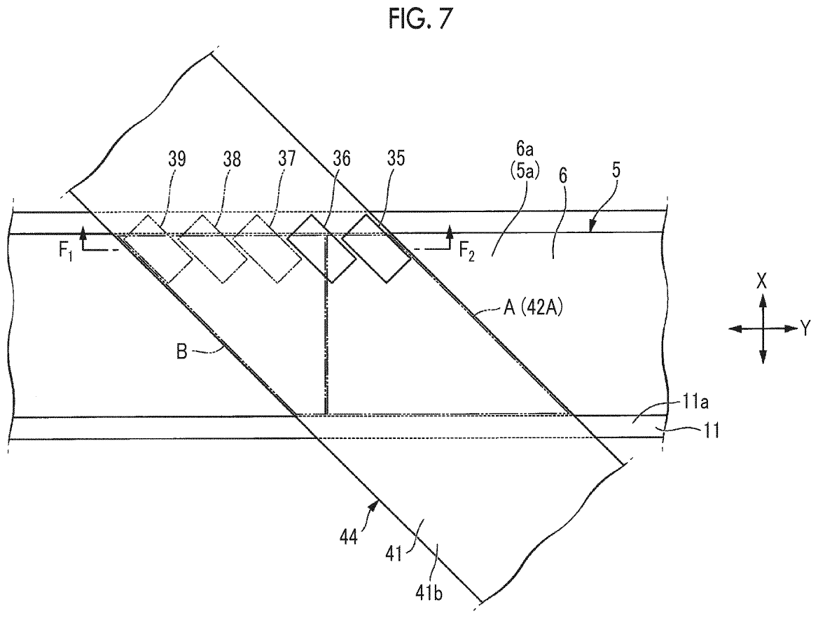

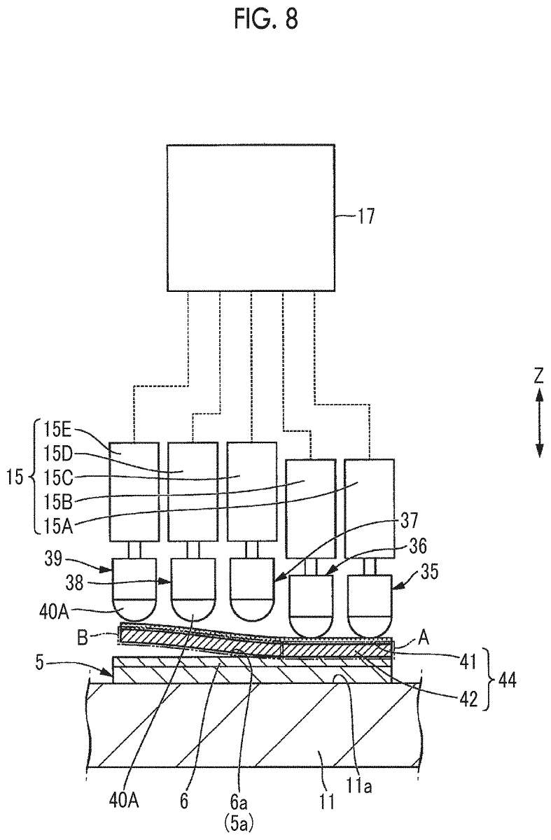

Next, immediately before the protrusion 40A of the compactor 37 moves to the pressing unnecessary region B, the compactor lifting and lowering control unit 17C causes the compactor 37 to be lifted, so that the protrusion 40A of the compactor 37 is separated above from the delamination sheet 41 (refer to FIGS. 7 and 8).

Thereafter, while the positions in the height direction of the compactors 35 to 39 are maintained, the compactors 35 to 39 move in the G direction to continue to press the predetermined region A, and in a stage where the protrusions 40A of the compactors 35 and 36 pass through a pressing end position (end of the prepreg cut portion 42A, which is located on one side in the width direction), the process of pressing the prepreg cut portion 42A is completed.

Since the control device 17 which performs the control described above is provided, only the predetermined region A (prepreg cut portion 42A) can be pressed without the pressing unnecessary region B being pressed.

Accordingly, the delamination of the prepreg sheet 42 (delamination of the prepreg sheet 42 from the delamination sheet 41) caused by the pressing of the pressing unnecessary region B can be suppressed.

In addition, in a previous stage of the pressing process, the prepreg cut portion 42A obtained by cutting a part of the prepreg sheet 42 into a predetermined shape is formed, and a portion corresponding to the prepreg cut portion 42A is pressed, so that the prepreg cut portion 42A can be layered on the lay-up stage or the upper surface 6a of the another prepreg sheet 6.

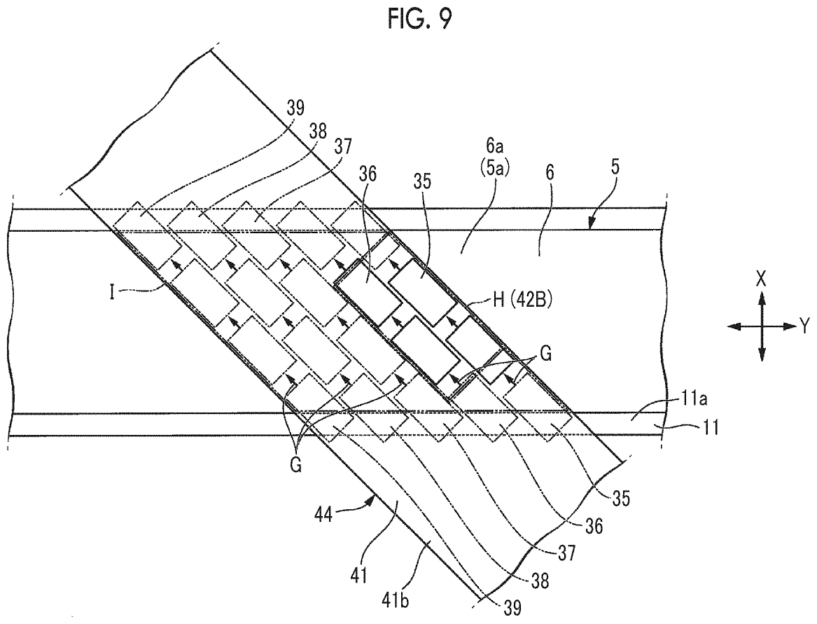

Here, referring to FIGS. 1 and 9, a lifting and lowering state of the compactors 35 to 39 will be described as an example based on when a prepreg cut portion 42B having a rectangular shape with a narrow width is layered on the upper surface 6a of the another prepreg sheet 6.

In FIG. 9, H indicates a predetermined region on the prepreg sheet 42, which is required to be pressed (hereinafter, referred to as a “predetermined region H”), and I indicates a region on the prepreg sheet 42, which is not required to be pressed (hereinafter, referred to as a “pressing unnecessary region I”). The predetermined region H is a region corresponding to the prepreg cut portion 42B.

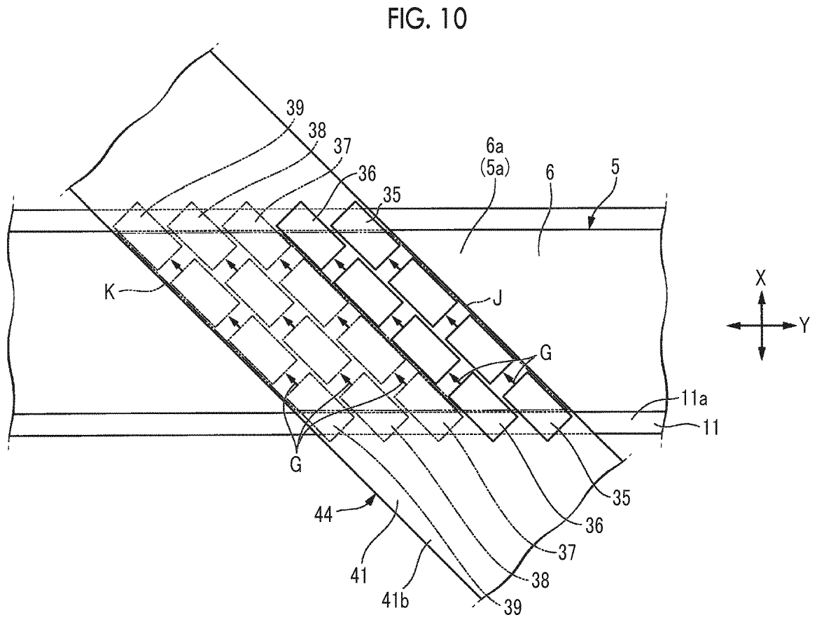

In addition, in FIG. 10, the compactors 35 and 36 indicated by solid lines are illustrated as pressing the delamination sheet 41, and the compactors 35 to 39 indicated by dotted lines are illustrated as being separated above from the delamination sheet 41.

In FIG. 9, the same components as those of a structure illustrated in FIG. 3 are denoted by the same reference signs.

As illustrated in FIG. 9, when only the prepreg cut portion 42B having a rectangular shape with a narrow width is pressed, the compactors 37 to 39 are always separated from the delamination sheet 41, and only the compactors 35 and 36 are lifted and lowered, so that the prepreg cut portion 42B can be layered on the upper surface 6a of the another prepreg sheet 6 without the pressing unnecessary region I being pressed.

Here, referring to FIGS. 1 and 10, a lifting and lowering state of the compactors 35 to 39 will be described as an example based on when a prepreg cut portion 42C having a parallelogram shape with a narrow width is layered on the upper surface 6a of the another prepreg sheet 6.

In FIG. 10, J indicates a predetermined region on the prepreg sheet 42, which is required to be pressed (hereinafter, referred to as a “predetermined region J”), and K indicates a region on the prepreg sheet 42, which is not required to be pressed (hereinafter, referred to as a “pressing unnecessary region K”). The predetermined region J is a region corresponding to the prepreg cut portion 42C.

In addition, in FIG. 10, the compactors 35 and 36 indicated by solid lines are illustrated as pressing the delamination sheet 41, and the compactors 37 to 39 indicated by dotted lines are illustrated as being separated above from the delamination sheet 41.

In FIG. 10, the same components as those of the structure illustrated in FIG. 3 are denoted by the same reference signs.

As illustrated in FIG. 10, when only the prepreg cut portion 42C having parallelogram shape with a narrow width is pressed, the compactors 37 to 39 are always separated from the delamination sheet 41, and only the compactors 35 and 36 are lowered, so that the prepreg cut portion 42C can be layered on the upper surface 6a of the another prepreg sheet 6 without the pressing unnecessary region K being pressed.

The prepreg automatic layering device 10 of the present embodiment is configured such that the compactors 35 to 39 disposed to be adjacent to each other in the Y direction are independent of each other, and includes the lifting and lowering mechanism 15 that independently lifts and lowers the compactors 35 to 39, and the control device 17 that controls the lifting and lowering mechanism 15. Therefore, while the compactors are located above the predetermined region A on the prepreg sheet 42, the compactors can be lowered to press the predetermined region A, and while the compactors are located above a region other than the predetermined region A on the prepreg sheet 42 (pressing unnecessary region B), the compactors can be lifted to not press the prepreg sheet 42.

Accordingly, the degree of freedom in the shape (including the outer shape and the width) of the prepreg cut portion 42A (predetermined region A on the prepreg sheet 42) pressed by the compactors 37 to 39 can be improved.

Incidentally, in the present embodiment, as an example, the case where the prepreg cut portion 42A, 42B, or 42C is layered on the another prepreg sheet 6 has been described; however, the prepreg cut portion 42A, 42B, or 42C may be layered on the lay-up stage 11.

In addition, in the present embodiment, as an example, the case where the prepreg layering head 13 has five compactors (compactors 35 to 39) is provided; however, the number of the compactors can be appropriately set and is not limited to 5.

In addition, when the prepreg cut portion 42A, 42B, or 42C is pressed, the compactors 35 to 39 may move slowly in the G direction. As described above, when the compactors 35 to 39 move slowly, the prepreg cut portion 42A, 42B, or 42C can be firmly pressed. Therefore, the delamination of the prepreg cut portion 42A, 42B, or 42C can be suppressed.

In addition, compactors other than the compactors 35 to 39 may be used and the prepreg cut portion 42A, 42B, or 42C pressed by the compactors 35 to 39 may be pressed again by the other compactors.

An exemplary embodiment of the present invention has been described in detail above; however, the present invention is not limited to such a specific embodiment, and various modifications and changes can be made without departing the concept of the present invention described in the claims.

### INDUSTRIAL APPLICABILITY

The present invention is applicable to the prepreg automatic layering device.

### REFERENCE SIGNS LIST

5 Prepreg layered body

5a, 6a, 11a Upper surface

6 Another prepreg sheet

10 Prepreg automatic layering device

11 Lay-up stage

13 Prepreg layering head

15 Lifting and lowering mechanism

15A to 15E Lifting and lowering portion

17 Control device

17A Clamp opening and closing control unit

17B Rotation drive control unit

17C Compactor lifting and lowering control unit

21 Feeding portion

23 Support roller

24 Rotary die cutter

25 Clamp portion

26, 27 Guide roller

29 Scraper roller

31 Winding portion

33 Rotation drive portion

35 to 39 Compactor

40A Protrusion

41 Delamination sheet

41a One surface

41b The other surface

42 Prepreg sheet

42A, 42B, 42C Prepreg cut portion

44 Sheet member

A, H, J Predetermined region

B, I, K Pressing unnecessary region

G Direction

1. A prepreg automatic layering device comprising:
a lay-up stage extending in one direction; and
a prepreg layering head including a feeding portion that feeds a prepreg sheet, which is affixed to one surface of a delamination sheet, onto the lay-up stage or another prepreg sheet disposed on the lay-up stage, a winding portion that winds the delamination sheet delaminated from the prepreg sheet, and a plurality of compactors that are disposed in the one direction and move in a direction from a winding portion side toward a feeding portion side to press a predetermined region on the prepreg sheet with the delamination sheet interposed between the plurality of compactors and the prepreg sheet,
wherein the plurality of compactors are disposed to be adjacent to each other on one side and are configured to be independent of each other, and
the prepreg layering head includes a lifting and lowering mechanism that independently lifts and lowers the plurality of compactors, and a control unit that controls the lifting and lowering mechanism.

2. The prepreg automatic layering device according to claim 1,
wherein while the compactor is located above the predetermined region on the prepreg sheet, the control unit performs control to lower the compactor to a position where the prepreg sheet is pressible, and while the compactor is located in a region outside the predetermined region on the prepreg sheet, the control unit performs control to lift the compactor above the prepreg sheet to cause the compactor to be separated from the delamination sheet.

3. The prepreg automatic layering device according to claim 1,
wherein the predetermined region on the prepreg sheet is a prepreg cut portion obtained by cutting a part of the prepreg sheet into a predetermined shape.

4. The prepreg automatic layering device according to claim 1,
wherein the prepreg layering head includes a cutter portion that is provided downstream of the feeding portion and in the proceding stage of the lay-up stage to cut the prepreg sheet in a width direction, and a clamp portion that clamps the delamination sheet and the prepreg sheet located between the feeding portion and the cutter portion, to stop feeding of the delamination sheet and the prepreg sheet, and
while the compactor presses the predetermined region on the prepreg sheet, the control unit controls the clamp portion to clamp the delamination sheet and the prepreg sheet and causes rotation of the winding portion to stop.
